(19) United States
(12) Patent Application Publication
(10) Pub. No.: US 2006/0196723 A1
(43) Pub. Date: Sep. 7, 2006

(54) Balloon speaker asembly

(76) Inventor: Fred I. White, Coquille, OR (US)

Correspondence Address: Boniard I. Brown;#113, 1500 West Covina Parkway, West Covina, CA, 91790-2793, US

(21) Appl. No.: 11/070,876

(22) Filed: Mar. 3, 2005

(51) Int. Cl. H04R 7/00; G10K 13/00

(52) U.S. Cl. 181/173

(57) ABSTRACT

A balloon speaker assembly has a magnet and coil adjacent thereto connected with electrical signal input, and a supporting structure.

### BACKGROUND AND SUMMARY OF THE INVENTION

A speaker design involves contention with the conflicting requirement that a low frequency speaker must move a large quantity of air in order to be effective, because of the relative insensitivity of the human ear at low frequencies. However, it must also be relatively light in weight so that it may follow signal contours accurately. This conflict is less severe in the mid-range frequencies.

A signal wave form complexity places demands on the system to accurately reproduce fine details in responding rapidly to signal variations. In the mid-range frequencies, the transducer is generally small, with low inertia. Transducers are generally smaller in the upper range of frequencies but must handle significant amounts of power. The problem of “beam” must be addressed, this being the tendency of high-frequency sound to concentrate in a narrow angle so that listeners may not be able to hear reproduced sound.

An advantage of the invention is that it does not restrict voice coil travel, there being no mechanical stop to limit stroke length. This eliminates “clipping” of of peaks of a wave form, which tend to occur at high volume levels and low frequencies, thus causing severe harmonic distortion common among conventional speaker designs.

Conventional speakers typically utilize relatively flat sheets of thin material as central transducer elements. Typically, a diaphragm may be formed of heavy paper-like material to provide stiffness, with edges thereof configured to allow a diaphragm to move back and forth somewhat in the manner of a piston.

Typically, a speaker is enclosed in a cabinet to prevent back radiation from a diaphragm from pulling about the edges of the diaphragm and cancel front radiation. The requirement for a cabinet tends to make speakers larger, heavier and relatively costly. The present invention eliminates the need for a cabinet, thus reducing both costs and size of equipment for all frequency ranges.

The generally spherical configuration of the transducer according to the invention decreases the severity of any back-wave cancellation problem. In conventional devices cancellation can occur when the back-wave joins the front wave at the front of the speaker one-half cycle later and 180° out of phase. The present invention admits wave fronts around the entire circle like ripples after a stone is dropped into water. The resultant wave is a composite of reflected portions of the original wave front, which will generally have traveled sufficiently far that they are much weakened.

The high degree of elasticity of the resilient sphere of the present invention, and its very small mass, provide very quick response time, thus enabling it to follow a wave form more closely than conventional systems.

The spherical transducer provides better coupling to air, the area of a sphere being four times that of a plane circular area of the same nominal diameter.

### BRIEF DESCRIPTION OF THE DRAWINGS

FIG. 1 is a perspective view of a preferred embodiment of the balloon loudspeaker according to the present invention; and

FIG. 2 is a sectional view taken at line 2-2 in FIG. 1 showing the balloon loudspeaker of the invention in relation to a coil and magnet.

### DESCRIPTION OF A PREFERRED EMBODIMENT

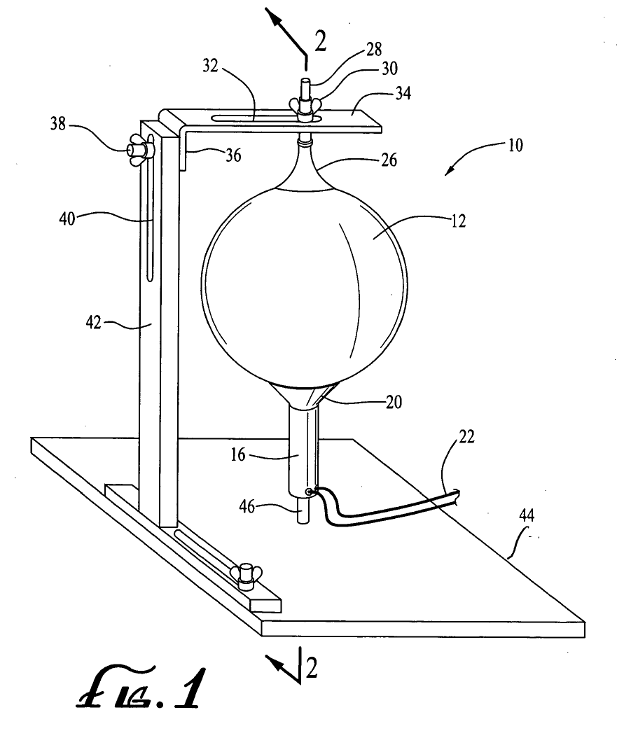

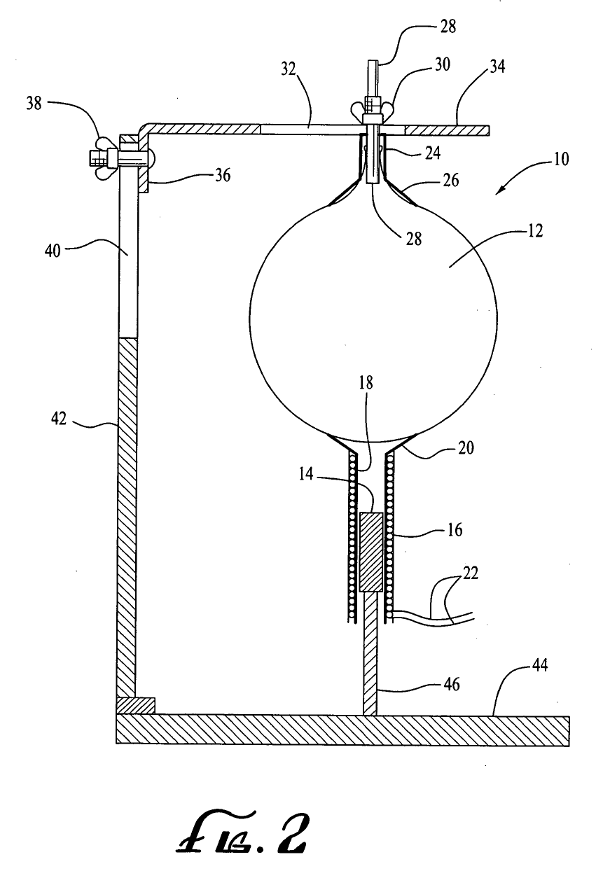

Referring to the drawings, FIGS. 1 and 2 show a preferred embodiment 10 of the invention comprising a speaker 12 in the form of a balloon, a magnet 14, secured by adhesive within a coil 16, and a generally tubular wall member 18 disposed in the coil and having a conical upper portion 20 to support the speaker 12. An electrical conduit 22 is connected with the coil.

Extending about the upper portion of the balloon is housing member 24 having a lower conical portion 26 engaging the upper portion of the balloon, as shown. The conical wall portions 20 and 26 are preferably adhered to the balloon by an appropriate adhesive.

A tubular member 28 has a threaded portion for securement by a wing nut 30 for adjustable securement of the tubular member in a slot 32 in an upper supporting arm 34, which is adjustable in orientation by loosening and tightening of a thumb screw 30 for alignment of the arm with the voice coil 16. An upper portion of tubular member 28 is adapted to engage in an inflation valve assembly (not shown) for inflation of the balloon speaker. A bent portion 36 in the upper frame member has an opening to receive a bolt member 38 which extends through a slot 40 in a vertical frame member 42. Member 42 is secured to and supported on a base member 44, as shown. A vertical support member 46 extends upwardly from base member 44 to support the magnet 14.

The present invention therefore provides a speaker assembly having a supporting frame, and a balloon speaker supported by the frame, with the frame supporting a magnet and a coil thereabout. The supporting frame comprises a horizontal base member, a vertical member, and an upper support member to adjustably mount the balloon.

It will be understood that various and modifications may be made from the preferred embodiment discussed above without departing from the scope of the present invention, which is established by the following claims and equivalents thereof.

1. A speaker assembly comprising:
an inflatable balloon speaker,
means to support upper and lower portions of the balloon speaker, and
an electrical coil disposed about a magnet and connected with electrical signal input to apply signal input to the balloon speaker.

2. A speaker assembly according to claim 1 wherein the support means comprises frame means to support the balloon speaker, the assembly comprising a base member, a generally vertical frame member and an upper horizontal frame member extending from the vertical frame member.

3. A speaker assembly according to claim 2 wherein said horizontal upper member defines a slot for lateral positioning of a reduced portion of the balloon speaker, and a threaded fastener disposed in the slot to retain the upper portion of the balloon speaker in selected position.

4. A speaker assembly according to claim 2 and further comprising a threaded fastener extending through a slot in the vertical frame member to engage and retain the upper horizontal frame member at a selected height for engagement with the balloon speaker.

5. A speaker assembly according to claim 2 and further comprising means extending from a lower frame member to support said magnet in said coil.

6. A speaker assembly comprising:
an inflatable balloon speaker,
frame means to support the balloon speaker comprising a base member, a generally vertical frame member and an upper horizontal frame member extending from the vertical frame member,
an electrical coil disposed about a magnet and connected with electrical signal input to apply signal input to the balloon speaker, and
speaker support means between said electrical coil and the balloon speaker.

7. A speaker assembly according to claim 6 and further comprising a frusto-conical member between said electrical coil to support a lower portion of the balloon speaker.

8. A speaker assembly according to claim 6 and further comprising a threaded fastener extending through a slot in the vertical frame member to engage and retain the upper horizontal frame member at a selected height for engagement with the balloon speaker.

9. A speaker assembly according to claim 6 and further comprising means extending from a lower frame member to support said magnet in said coil.

10. A speaker assembly according to claim 6 and further comprising a threaded fastener extending through a slot in the vertical frame member to engage and retain the upper horizontal frame member at a selected height for engagement with the balloon speaker.
